(19) United States
(12) Patent Application Publication
(10) Pub. No.: US 2003/0115116 A1
(43) Pub. Date: Jun. 19, 2003

(54) Publishing information on the internet

(75) Inventor: Martin Andrew Crampton, Berwick (AU)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Newbrain Technologies Pty Limited, Melbourne (AU)

(21) Appl. No.: 10/274,069

(22) Filed: Oct. 18, 2002

Related U.S. Application Data
(63) Continuation of application No. PCT/AU01/00439, filed on Apr. 18, 2001.

(30) Foreign Application Priority Data
Apr. 18, 2000 (AU) PQ 6978

(51) Int. Cl. G06F 17/60

(52) U.S. Cl. 705/27

(57) ABSTRACT

A method of publishing information on the Internet, includes the step of a publishing service provider establishing an Internet publishing site. A person who wishes to publish information accesses the Internet publishing site and registers as a client. During the registration process, the client chooses: (a) to provide details of the client's existing Internet site; and/or (b) to request the publishing service provided to provide an Internet site for the client, or (c) not to utilize a “traditional” Internet web site. The information to be published is transferred from the client to the Internet publishing site. Software on the Internet publishing site automatically converts the information into a content item in a format suitable for placing on an Internet site, automatically allocates a URL (uniform resource locater) to the content item, and automatically enables the content item to be visible on the Internet.

### CROSS REFERENCE TO RELATED APPLICATIONS

The present application is a continuation of International Application No. PCT/AU01/00439, filed on Apr. 18, 2001, in the English language, the disclosure of which is incorporated by reference herein.

### FIELD OF THE INVENTION

This invention relates to a method of publishing documents and content items on the Internet. It relates particularly but not exclusively to a method in which information in an “ordinary” or non-Internet format is transformed into an active Internet content item which interacts with numerous communication opportunities and mechanisms.

### BACKGROUND TO THE INVENTION

One of the significant problems for a business in engaging the power of the Internet for promotional information distribution purposes is the need to either have their own Internet web site or to post or register information onto an Internet web site(s) controlled by some-one else.

There are several significant problems in maintaining an Internet presence. They include the complication and expense involved in constructing and maintaining an Internet web site. It is necessary to understand how to obtain a domain name and website space, how to design the web site, how to format documents appropriately for Internet usage, how to post those documents to the web site, and how to keep those documents updated. The webmaster needs the skills of a graphic designer, a journalist, and a programmer. Because good webmasters are relatively rare, it is common for organizations to have no website at all, or to have a poorly designed and inadequately maintained website, or to incur significant expense in having an internal consultant design and maintain a website.

In addition to the problems associated with creating and maintaining websites, there are problems associated with letting customers and associates know of its existence. There are various resources on the Internet which facilitate the finding of relevant web sites, including Internet search engines such as Altavista, directories such as Yahoo!, and various portals. A web site operator can register with one or more of these web site locating services, either for free or after payment of a fee. The service then indexes the operator's web site, and Internet users who use the web site locating service can then find the operator's web site by executing a query with appropriate key words or navigating to an appropriate position in a directory tree.

Different procedures are involved in registering with different web site locating services, and, if a web site operator wants his or her site to be located by as many Internet users as possible, it can be quite complicated finding all of the relevant web site locating services and then going through a separate registration procedure with each. Some services such as search engines may require the web site operator to complete a questionnaire and submit information such as key words and the web site's URL (uniform resource locater), whereafter the search engine will “spider” the operator's web page in order to obtain and index relevant information, using in particular the web page title and meta-tags.

Various attempts have been made to make it easier for people to create Internet web sites. Various common applications such as word processors sometimes have options allowing the user to save a document in web page format. However, this does not resolve the technical complexity associated with establishing a hosting service for the Web site, posting documents and other material to such a remote web site and submitting web pages to web site locating services. Furthermore, such web-page-format options often result in bulky and inefficient web page coding.

Other attempts approach the problem from a different angle. Some web page hosting services allow a user to create an instant web page by typing in a title and then typing in the content. However, such web pages are typically inflexible in appearance, and the ability to create links, add more pages, provide content databases or register with web site locating services is limited.

The object of the present invention is to overcome or alleviate one or more of the problems and/or limitations present in the prior art.

### SUMMARY OF THE INVENTION

According to a first aspect of the present invention, there is provided a method of publishing information on the Internet, comprising the following steps:

(a) an Internet publishing site is established by a publishing service provider;

(b) a person who wishes to publish information accesses the Internet publishing site and registers as a client;

(c) during the registration process, the client chooses:

(i) to provide details of the client's existing Internet site; and/or

(ii) to request the publishing service provider to provide an Internet site for the client; or

(iii) to not use a ‘traditional’ Internet web site

(d) the information to be published is transferred from the client to the Internet publishing site;;

(e) software on the Internet publishing site automatically converts the information into a content item in a format suitable for placing on an Internet site, automatically allocates a URL (uniform resource locater) to the content item, and automatically enables the content item to be visible on the Internet.

A “content item” may consist of or comprise text, one or more images, a video file, a sound file, a database, or any other suitable type of content. The information transferred from the client to the Internet publishing site may comprise information in the form of a content item. The information may be transferred in any suitable manner comprising by transferring a content item or by direct entry into the Internet publishing site.

The Internet publishing site may provide the client with options whereby the client may select the site(s) or organizations(s) to which the content item is to be linked. If the client has provided details of an Internet site or requested an Internet site during the registration process, the content item may become accessible from the client's Internet site by means of a link from that site to the Internet publishing site.

According to a preferred feature of this aspect of the invention, the content item or a part of its content or a link to the content is also forwarded by the Internet publishing site to one or more of:

(a) a list of email addresses as an email or an email attachment;

(b) one or more other Internet sites for posting in either an HTML format or other content item format meeting the requirements of the Internet site on which the content item, part thereof or link thereto will be posted.

This enables distribution of the link or the content item to email addresses of news-providing organizations and other email recipients, and posting to industry portals.

The content item may also be made available for access by any web site which has a link to the publishing service web site. This enables distribution of content to websites of clients or associates and the greater Internet web site environment via access to the publishing web site under the indexing selected by the client at the time of registering their content.

The content item may also be registered with one or more Internet search engines, directories, portals or other resource locaters, by forwarding to the Internet search engines, directories, internet sites, portals or other resource locaters details of the URL allocated by the Internet publishing site to the content item and optionally one or more of:

(a) a copy of the content item;

(b) information entered by the client;

(c) information extracted from the content item;

(d) meta-information inserted into the content item during the format conversion step;

(e) other information provided by the client during the registration process;

(f) other information created/provided by the Internet publishing site relating to the content item/content.

This registration is, preferably, automatically performed by the Internet publishing site. The registration may be effected by directly indexing the content item with an Internet search engine, directory, internet site, portal or other resource locator. Another method of registration is by attaching the content item to a page which is already visible to the relevant resource locator.

This preferred feature provides significant value to the client in that it saves time in finding and registering with resource locaters, and reduces the amount of technical expertise required to do so.

The format conversion step may involve any suitable format conversion process. Preferably, the step involves one or more of:

(a) inserting meta-information into the content item;

(b) inserting hypertext links and/or graphical links into the content item;

(c) preparing multiple different versions of the content item in different formats which comply with the formatting requirements of different Internet sites, Internet search engines, directories, portals or other resource locaters.

Alternatively or additionally, the format conversion step may comprise inserting into the content item buttons or other graphical or hypertext links relating to predetermined categories.

For example, links in the form of “News, People, Product-type” buttons into the client's and or associates Website(s) by the client inserting relevant html code web site links obtained from the publishing service web site. Buttons or other graphical or hypertext links relating to “News/Information”, “Products/Services” and “Profile/People” may also be inserted into the content item. It will be appreciated that there can be any number of particularly suitable categories by which the links may be categorized.

The format conversion step may, alternatively or additionally comprise, inserting into the client's and/or associates Internet site(s) buttons or other graphical or hypertext links relating to one or more content items placed on the Internet according to this invention.

The method may comprise the following additional steps:

(a) an Internet user locates the content item or a reference to the content item using an Internet search engine, directory, portal, Internet site or other resource locater;

(b) the Internet user uses the content item to purchase a product or service;

(c) a portion of the payment made by the Internet user is paid to the operator of the Internet publishing site.

As a still further alternative or additional step the method may comprise the following steps:

(a) an Internet user locates the content item or a reference to the content item using an Internet search engine, directory, internet site, portal or other resource locator;

(b) the Internet user views the content item; and

(c) a fee is levied for the viewing of the content item, the fee being levied by the Internet publishing site and payable by the client.

According to a second aspect of the invention, there is provided a method of publishing a content item on the Internet, comprising the following steps:

(a) a person who wishes to publish the content item establishes an Internet connection with an Internet publishing site;

(b) the person registers the content item with the Internet publishing site, providing information concerning categories and/or key words, and uploads the content item to the site;

(c) the Internet publishing site automatically translates the content item into HTML (Hyper Text Mark-up Language) and inserts meta-tags and creates an indexing file using information concerning categories and/or key words provided by the person during the registration step and/or information extracted automatically from the content item;

(d) the content item is automatically indexed into a database associated with the Internet publishing site;

(e) hypertext and/or graphical links are inserted into the content item;

(f) the content item is automatically allocated a URL and forwarded to a publicly accessible Internet site, with the content item or part of it or a link to it optionally being forwarded to one or more of the following:

(i) one or more websites associated with clients and alliances of the person;

(ii) a list of email addresses;

(iii) the submission area of one or more Internet search engines or directories;

(iv) one or more industry portals or other resource locaters.

The content item can be uploaded on the Internet publishing site in any suitable manner. A particularly suitable manner is by having the person enter information making up the content item directly into the Internet publishing site. Another particularly suitable manner is by transferring a document containing the content item to the Internet publishing site.

Copies of the content item or parts of the content item or information about the content item or links to the part or whole of the content item may automatically be created in a plurality of different formats and forwarded to a plurality of different locations, each format complying with the requirements of the destination to which it is forwarded, thereby saving considerable time in locating suitable resource locaters, format conversion and complying with individual registration peculiarities. The hypertext and/or graphical links inserted into the content item may comprise links that are common in nature to those appropriate for most Internet web pages. It has been found that the categories “News/Information”, “Products/Services” and “Profile/People” are particularly suitable for most Internet sites. However, there are other categories which may alternatively or additionally be used. The buttons may also be inserted by the client and their associates into web sites for user access to the content. The content is preferably “tagged” with the types of button category for search purposes. It is preferred that these particular links or “tags” be recognisable to search engines, directories and other resource locaters, enabling those search engines, directories and other resource locaters to link directly to content associated with those links. Thus, for example, the results page of a search engine search might come up with a hypertext link to a particular web page, but in the same line it may also comprise “News/Information”, “Products/Services” and “Profile/People” buttons, because the search engine has detected that the listed web page has links corresponding with these standard categories.

Even if the search engine tag detection capability is not possible in the first instance, the fact that all content pages are allocated metatags and provide search engines with access to their URL's etc means search engines can locate the content, whereas this is not always possible at the moment when content is registered on a portal which “shields” the search engines from seeing the content. By registering content to portals via the publishing service system of the present invention the content is made visible to search engines.

The step of registering the content item with the Internet publishing site may comprise options for selecting sites or organizations to which the content item is to be linked. Thus, for example, there may be a standard list of organizations for whom there are predefined links which can be selected. This enables the web site creator to specify a list of “marketing alliances” such as preferred professional associations, preferred bank (selected from a standard list of banks or added on an individual basis), preferred accountant, preferred law firm, preferred courier service, and so on. The selected marketing alliances links are then visible either individually or as a group from which the individual alliance can be accessed.

Additionally or alternatively, the step of registering the content item with the Internet publishing site may comprise options for selecting other previously registered content items to which the current content item is to be linked. Thus, for example, there may be a previously registered ‘Property’ item, and the person registering the current item may believe there may be some benefit for potential viewers of the Property item in having more immediate access to a linked “News release”, “Valuation” or “Finance” detail. This enables the web site creator to specify links between several content items.

The created links are then visible for each of the related content items from which the individual items can be accessed from any one of the other content items.

The method may comprise the following additional steps:

(a) an Internet user locates the content item or a reference to the content item using an Internet search engine, directory, portal, Internet site or other resource locater;

(b) the Internet user uses the content item to purchase a product or service;

(c) a portion of the payment made by the Internet user is paid to the operator of the Internet publishing site.

As a still further alternative or additional step the method may comprise the following steps:

(a) an Internet user locates the content item using an Internet search engine, directory, internet site, portal or other resource locator;

(b) the Internet user views the content item; and

(c) a fee is levied for the viewing of the content item, the fee being levied by the Internet publishing site and payable by the client.

It is anticipated that revenue will be derived (1) from registration of documents or content items using the Internet publishing site, (2) for the accessing and subsequent viewing of each published document or item. This model then, in which the Internet publishing site (and optionally also the referring search engine, directory, portal, Internet site or resource locater) is compensated when a “view” and/or purchase is made through a document or content item which has been published by the publishing site, ensures that the publishing site is rewarded for actual value created for the client, rather than merely for potential exposure.

### BRIEF DESCRIPTION OF THE DRAWING

The invention will now be described in further detail by reference to the enclosed drawing showing an example form of the invention. It is to be understood that the particularity of the drawing does not supersede the generality of the preceding description of the invention.

FIG. 1 is a schematic diagram of information flow according to an embodiment of the invention.

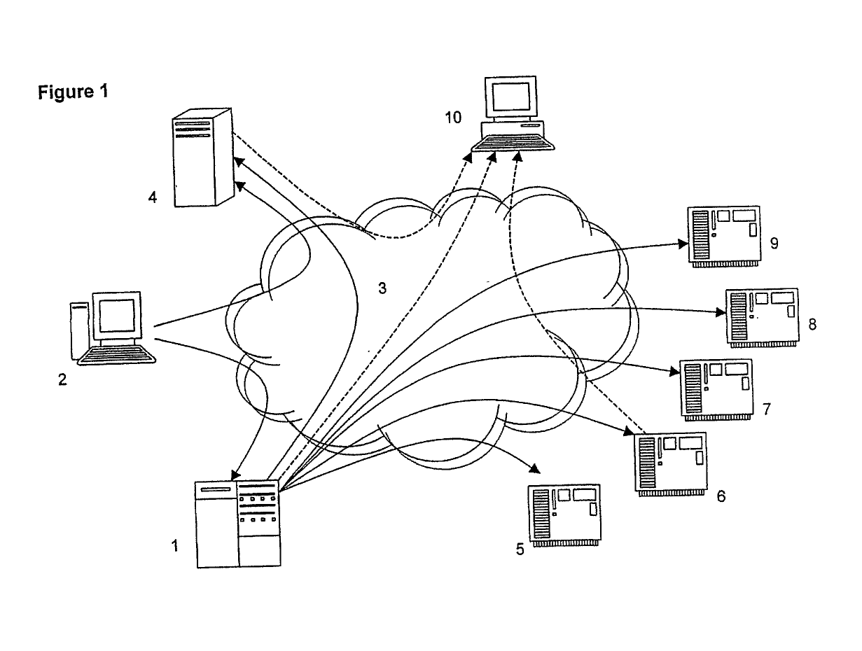

### DETAILED DESCRIPTION

In the method illustrated, an Internet publishing site 1 is established by a publishing service provider. A person who wishes to publish information accesses Internet publishing site 1 from computer 2 via Internet 3 and registers as a client. During the registration process, the client chooses either to provide details of the client's existing Internet site 4 or to request the publishing service provider to provide an Internet site for the client. The information to be published can be uploaded by the client to the Internet publishing site 1 either as a content item in a standard file format or by having the client directly enter the information into the Internet publishing site 1.

Software on Internet publishing site 1 automatically converts the information into a format suitable for placing on an Internet site, automatically allocates a URL (uniform resource locater) to the content item and automatically makes the whole or part of the content item's content accessible from the client's Internet site 4 or that of the client's alliances as long as they have a link to the publishing service web site.

The content item may also be automatically forwarded by Internet publishing site 1 to a list of email or fax addresses as an email or an email attachment and/or to one or more other Internet sites for posting, as an HTML document.

Depending upon the nomination of the client, the content item may also automatically be registered with one or more Internet search engines 5, directories 6, portals 7 or other resource locaters 8, 9, by forwarding to the Internet search engines 5, directories 6, portals 7, Internet sites or other resource locaters 8, 9 details of the URL allocated by the Internet publishing site 1 to the content item. Depending on the requirements of the particular resource locater, there may also be forwarded a copy of the content item, information extracted from the content item content item, meta-information inserted into the content item during the format conversion step, and/or other information provided by the client during the registration process and/or additional information provided by the Internet publishing site for the indexing or searching resource locators.

In a preferred embodiment, the method of the present invention does four main things either automatically or following nomination by the client:

1. Enables posting of an ordinary PC word processing document, directly entered content, product catalogue or data set in an accessible format so that a Search engine can locate it (without needing a pre-established Website), and classify and categorise it descriptively and intelligently. (Many Websites and the individual content items within them cannot be found or are not currently found by Search engines and those that are found are listed without functional attributes e.g. This functionality can enable such action from a Search engine as “Press here for direct access to this site's products”.)

2. Enables creation of an online product Website brochure page or catalogue without needing a pre-established Website.

3. Distributes the information to several Search engines, Websites or portals.

4. Distributes the information to media outlets that can be selected from lists and to other contacts which can be added.

If the person wishing to post a document already has an established Website, the method of the present invention:

Makes the document or other various form of content item available for access through it and indexes it so users can find it easily and directly or indirectly.

Makes the document available for access through any branch or alliance Websites and indexes it according to the indexing selected by the client at the time of posting/registration, so users can find it easily.

Publishes the document on a central site, guaranteeing its publication and making it available for access to anyone.

Posting an item using the method of the present invention organizes it on the client's Website with no further ado. The method can be further expanded so that, simply by placing an appropriate link to the relevant information in the publishing site via a ‘News’, ‘Products’, ‘People’ or relevant button provided by the Internet publishing site on the client's Website the client can ensure that whenever an item is posted using the method of the invention that item will fit directly behind the right button and be indexed in the correct order.

According to a preferred revenue model, all information posted according to the inventive method may be accessed by public users free of charge. Clients are charged either a periodic fee for use of the service or a fee per document or content item posted or a fee per view of the document or content item by public users. Clients may also be charged a percentage of sales made through a web page which has been posted according to the inventive method.

A client only has to register once to post information using the inventive method. On registration the client is allocated a User name and Password which can then be used to post information at any time.

The method of the invention may further provide for authentication of posted information. The Internet publishing site may require the client to state who they are and which organisation they represent. This enables the publishing site to ascertain the identity of any person posting material to a web site or posting a press release or other document to an email distribution list.

When posting a document or other content item using the inventive method, the client is preferably prompted to select one or more categories to which the document relates. These categories can be used to assist in generating meta-information for the document. One suitable categorisation of different subject matter is given in the following table:

| | |
|---|---|
| Media, Media events, | TV, Radio, Press, |
| Conferences, Marketing, | Internet, “Other |
| Sales, Promotion, | Communications”, Events, |
| | People, Issues |
| Government | Politics, Gov. Depts |
| “Primary industries”, | Farming, Scientific, |
| Agriculture, | Consumer, End-users |
| Horticulture, Forestry, | |
| Fishing | |
| Mining, Industry, | Construction, Commerce, |
| Manufacturing | Products, Services, |
| | People, (Synthetics, |
| | Metal, Wood, Chemical, |
| | Food) |
| Property, Realty, | Residential, Commercial, |
| Construction | Industrial, Retail, |
| | Investment, Rural |
| Consumer, Shopping, House | “Food/Drink”, Clothing, |
| & Home, Family | Handyman, Auto, Home, |
| | Children, Babies, |
| | Personal, Hygiene, Pets |
| Lifestyle, Recreation, | Performing arts, Games, |
| Events, Entertainment, | Movies, Music, Humour, |
| Sports, Festivals | Clothing, (Food/Drink), |
| | Hobbies |
| “Other People” | Chat, Email, Forums, |
| | Personals, Relationships, |
| | Finding people |
| Weather, Horoscopes, | Education, Scientific, |
| Maps | Business |
| Education, Studies, | Pre-School, Primary, |
| Training, Reference | Secondary, Tertiary, |
| | Further, Workplace, |
| | Humanities, Sciences, |
| | Society |
| Science, Technology | Education, Research, |
| | Business |
| Computers, Internet, | Networks, Hardware, |
| Telecommunications | Software, Services, |
| | Companies, Infrastructure, |
| | Products, Services |
| Travel, Tourism | Destinations, |
| | Accommodation, |
| | Transportation, Products, |
| | Services |
| Commerce, Business, | Companies, Industries, |
| Financial, Insurance, | Professions, Banking, |
| Corporate, “Stock | Finance, Insurance, |
| market”, Legal, | Economics, Superannuation, |
| Utilities | Investment, Mergers, |
| | Acquisitions, Issues, |
| | Cases |
| The Workplace, | “Industrial relations”, |
| “Industrial relations”, | Rules, Standards, Safety, |
| “Human Resources”, | Jobs |
| Employment | |
| Medical, Healthcare, | Products, Services, Issues |
| Fitness | |
| Community, Religion, | Clubs, Associations, |
| Beliefs, Society, Local, | Charities, “Social |
| “Gender issues” | welfare”, Christian, |
| | Muslim, Hindu, Buddhist, |
| | Jewish (Other) |
| Indigenous, Ethnic | Policy, Issues |
| (Affairs), Immigration | |
| Transport | Road, Rail, Air, Space |
| Automotive, Power | Cars, Trucks, Care, Parts, |
| | Accessories |
| Hardware, Tools | Wholesale, Retail, |
| | Professional |

Note that the invention enables quick reference searches via more general classifications as well as more specific searches via more specific classifications. The invention automates some of the classification information without the need for additional client input.

In addition to selecting one or more categories, the client is preferably prompted to enter a heading, and geographical information specifying country/state/city/suburb/postal code (if relevant). These items of information can also be used in generating meta-information for the content item and in generating standard-format information for submission to search engines, directories, portals and other resource locaters. In addition, this invention may provide certain document content items with unique classifications for particular/individual resource locators. Keywords which can be edited by the client can be generated automatically by an interrogation of the document or content item.

Also at the time of posting a document or content item, the client is preferably given options concerning email and fax addresses to which the content item will be forwarded. These options preferably comprise selecting from a list of journalists and media organizations, real estate agencies and agents and other relevant destinations with an option to add and organise further addresses.

At the time of posting, the client may also be presented with a choice of layout templates (comprising an option for creating their own template style) for the various types of content, particularly if the content item is a product catalogue or similar document. The client can then upload images and other content items to achieve an appearance determined by the template.

Also at the time of posting, the client may be given the option to specify “marketing alliances”. The client may, for example, have a special relationship with a particular bank, a particular firm of accountants, a particular advertising agency, and a particular airline. By entering these details or selecting from a predefined list, the client could request the automatic insertion of hyperlinks in the content item linking the content item to these allied parties.

Additionally, the client may choose to link various existing content items with the new content being added. By nominating these links, the client could request the automatic insertion of hyperlinks in the content item thereby linking the content item to these related forms of content.

As a further enhancement to the service provided by the Internet publishing site to clients, the Internet publishing site may index the contents of clients' posted content items, by “spidering” or any other suitable technique. This may involve the publishing site copying pre-existing content/data, as entered by clients, from other web sites onto the main publishing site in addition to making this accessible to the client and their associates' web sites. This availability may be contingent on the client's approval or on a link being maintained with the Internet publishing site.

The client may elect to insert “News, Product, Profile” or other relevant content classifications as “search” buttons on their Web site, which then enables a person visiting the client's site to conduct a search of the client's content items which have been posted/registered via the Internet publishing site.

It will be appreciated that the method of the present invention is useful not only to those who do not wish to maintain their own Internet sites but still have content published as widely as possible and those who wish to maintain their own Internet sites in a simple and cost-effective manner, but also to those who wish to post pages to sites maintained by others. For example, there may be an automobile sales site, to which individual car dealers regularly post details of the vehicles which they have for sale. According to current practice, information posted in this way can often only be accessed using the search engine provided by the automobile sales site itself. If, on the other hand, the car dealers choose to post the information to the automobile sales site via the method of the present invention, they have numerous options regarding accessibility of the information. For example, they could elect to post the information to other sites and/or portals simultaneously. They could choose to submit details to a search engine, which would then make the information accessible directly through that search engine and not just through the automobile sales site engine. They could choose to comprise the “News, Profiles, Products” buttons or hyperlinks on the pages which they post, providing links to other information posted/registered with the Internet publishing service and other sites.

It is to be understood that various additions, alterations and/or modifications may be made to the parts described previously without departing from the ambit of the invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of publishing information on the Internet, comprising the following steps:
(a) an Internet publishing site is established by a publishing service provider;
(b) a person who wishes to publish information accesses the Internet publishing site and registers as a client;
(c) during the registration process, the client chooses:
(i) to provide details of the client's existing Internet site; and/or
(ii) to request the publishing service provider to provide an Internet site for the client; or
(iii) to not utilize a “traditional” Internet web site
(d) the information to be published is transferred from the client to the Internet publishing site;
(e) software on the Internet publishing site automatically converts the information into a content item in a format suitable for placing on an Internet site, automatically allocates a URL (uniform resource locater) to the content item, and automatically enables the content item to be visible on the Internet.

2. A method according to claim 1 wherein the information to be published is a document in a standard file format which is transferred from the client to the Internet publishing site.

3. A method according to claim 1 wherein the information to be published is entered into the Internet publishing site by the client.

4. A method according to claim 1 wherein the step of registering the content item with the Internet publishing site comprises options for selecting sites or organizations to which the content item is to be linked.

5. A method according to claim 1 wherein if the client has provided details of an Internet site or requested an Internet site during the registration process, the content item becomes accessible from the client's Internet site by means of a link from that site to the Internet publishing site.

6. A method according to claim 1 wherein the content item or part of its content or a link to the content is also forwarded by the Internet publishing site to one or more of:
(a) a list of email addresses as an email or an email attachment;
(b) one or more other Internet sites for posting, in either HTML format or other format meeting the requirements of the Internet site on which the content item, part thereof or link thereto will be posted.

7. A method according to claim 1 wherein the content item is also registered with one or more Internet search engines, directories, Internet sites, portals or other resource locaters, by forwarding to the Internet search engines, directories, Internet sites, portals or other resource locaters details of the URL allocated by the Internet publishing site to the content item and optionally one or more of:
(a) a copy of the content item;
(b) information entered by the client
(c) information extracted from the content item;
(d) meta-information inserted into the content item during the format conversion step;
(e) other information provided by the client during the registration process;
(f) other information created/provided by the Internet publishing site relating to the content item/content.

8. A method according to claim 1 wherein the format conversion step involves one or more of:
(a) inserting meta-information into the content item;
(b) inserting hypertext links and/or graphical links into the content item;
(c) preparing multiple different versions of the content item in different formats which comply with the formatting requirements of different Internet sites, Internet search engines, directories, Internet sites, portals or other resource locaters.

9. A method according to claim 1 wherein the format conversion step comprises inserting into the content item buttons or other graphical or hypertext links relating to predetermined categories.

10. A method according to claim 9 wherein one or more of the predetermined categories are selected from a group consisting of the following categories:
(a) “News/Information”;
(b) “Products/Services”; and
(c) “Profile/People”.

11. A method according to claim 1 comprising the following additional steps:
(a) an Internet user locates the content item or a reference to the content item using an Internet search engine, directory, portal or other resource locater;
(b) the Internet user uses the content item to purchase a product or service; and
(c) a portion of the payment made by the Internet user is paid to the operator of the Internet publishing site.

12. A method according to claim 1 comprising the following additional steps:
(a) an Internet user locates the content item or a reference to the content item an Internet search engine, directory, portal or other resource locator;
(b) the Internet user views the content item; and
(c) a fee is levied for the viewing of the content item, the fee being levied by the Internet publishing site and payable by the client;

13. A method of publishing a content item on the Internet, comprising the following steps:
(a) a person who wishes to publish the content item establishes an Internet connection with an Internet publishing site;
(b) the person registers the content item with the Internet publishing site, providing information concerning categories and/or key words, and uploads the content item to the site;
(c) the Internet publishing site automatically translates the content item into HTML (Hyper Text Mark-up Language) and inserts meta-tags and creates an indexing file using information concerning categories and/or key words provided by the person during the registration step and/or information extracted automatically from the content item;
(d) the content item is automatically indexed into a database associated with the Internet publishing site;
(e) hypertext and/or graphical links are inserted into the content item;
(f) the content item is automatically allocated a URL, with the content item or part of it or a link to it optionally being forwarded to one or more of the following:
(i) one or more websites associated with clients and alliances of the person;
(ii) a list of email addresses;
(iii) the submission area of one or more Internet search engines or directories;
(iv) one or more industry portals or other resource locaters.

14. A method according to claim 13 wherein the content item is uploaded onto the publishing site by entering information consisting of the content item into the publishing site.

15. A method according to claim 13 wherein the content item is uploaded onto the publishing site by transferring a document consisting of the content item to the publishing site.

16. A method according to claim 13 wherein copies of the content item or parts of the content item or information about the content item or links to the content item are automatically created in a plurality of different formats and forwarded to a plurality of different locations, each format complying with the requirements of the destination to which it is forwarded.

17. A method according to claim 13 wherein the hypertext and/or graphical links inserted into the content item comprise links which are common in nature to those appropriate for most Internet web pages.

18. A method according to claim 13 wherein the links and their associated indexing codes are recognisable to search engines, directories and other resource locaters, enabling those search engines, directories and other resource locaters to link directly to content associated with those links.

19. A method according to claim 13 wherein the step of registering the content item with the Internet publishing site comprises options for selecting sites or organizations to which the content item is to be linked.

20. A method according to claim 13 comprising the following additional steps:
(a) an Internet user locates the content item or a reference to the content item using an Internet search engine, directory, portal or other resource locater;
(b) the Internet user uses the content item to purchase a product or service;
(c) a portion of the payment made by the Internet user is paid to the operator of the Internet publishing site.

21. A method according to claim 13 comprising the following additional steps:
(a) an Internet user locates the content item or a reference to the content item using an Internet search engine, directory, Internet site, portal or other resource locator;
(b) the Internet user views the content item;
(c) a fee is levied for the viewing of the content item, the fee being levied by the Internet publishing site and payable by the client.

22. A method according to claim 13 wherein the content item is linked to a content item previously published using the Internet publishing site.

23. A method according to claim 1 or claim 13 wherein the Internet publishing site inserts into the content item one or more hyperlinks to content items previously published by the Internet publishing site.
